(19) United States
(12) Patent Application Publication
(10) Pub. No.: US 2008/0232493 A1
(43) Pub. Date: Sep. 25, 2008

(54) COMBINED PRECODING VECTOR SWITCH AND FREQUENCY SWITCH TRANSMIT DIVERSITY FOR SECONDARY SYNCHRONIZATION CHANNEL IN EVOLVED UTRA

(75) Inventors: Guodong Zhang, Farmingdale, NY (US); Kyle Jung-Lin Pan, Smithtown, NY (US); Allan Yingming Tsai, Boonton, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/051,380

(22) Filed: Mar. 19, 2008

Related U.S. Application Data
(60) Provisional application No. 60/895,623, filed on Mar. 19, 2007.

(51) Int. Cl. H04L 27/28; H04J 1/00; H04J 3/06

(52) U.S. Cl. 375/260; 370/343; 370/350

(57) ABSTRACT

A method of providing transmit diversity for a secondary synchronization channel (S-SCH) includes generating a S-SCH signal, performing a frequency switched transmit diversity (FSTD) process on the S-SCH signal to create a first processed signal, performing a precoding vector switching (PVS) process on the first processed signal to create a processed S-SCH signal, and transmitting the processed S-SCH signal.

### CROSS REFERENCE TO RELATED APPLICATIONS

This application claims the benefit of U.S. provisional application No. 60/895,623 filed Mar. 19, 2007 which is incorporated by reference as if fully set forth.

### FIELD OF INVENTION

This application is related to wireless communications.

### BACKGROUND

The third generation partnership project (3GPP) and its progeny 3GPP2, are directed towards the advancement of technology for radio interfaces and network architectures for wireless communication systems. Part of 3GPP involves the use of orthogonal frequency division multiple access (OFDMA) as a technology for downlink (DL) communications in an evolved UMTS terrestrial radio access (e-UTRA) network. At initial access, a wireless transmit/receive unit (WTRU) may receive and process a primary synchronization channel (P-SCH) and a secondary synchronization channel (S-SCH) in order to acquire timing, frequency offset, and a cell identification (ID).

At initial cell search, the S-SCH may be received by the WTRU. However, the WTRU has no knowledge of the number of transmit antennas at the cell. Therefore, it is preferable that a transmit diversity scheme not requiring knowledge of the number of transmit antennas be used in the network. Several transmit diversity schemes, such as time switched transmit diversity (TSTD), frequency switched transmit diversity (FSTD) and precoding vector switching (PVS) have been considered.

It would be desirable to have a transmit diversity scheme for the S-SCH for an e-UTRA network that achieves high performance.

### SUMMARY

A method and apparatus is disclosed for providing transmit diversity for a secondary synchronization channel (S-SCH). This may include applying a FSTD process and a PVS process to a S-SCH prior to transmitting the S-SCH.

More specifically, the S-SCH may be processed with an FSTD to a first orthogonal frequency domain multiplexed (OFDM) symbol with a first sequence in a lower bandwidth and a second sequence in an upper bandwidth and a second OFDM symbol with the first sequence in the upper bandwidth and the second sequence in the lower bandwidth. A precoding matrix may be applied to the first and second symbols.

### BRIEF DESCRIPTION OF THE DRAWINGS

A more detailed understanding may be had from the following description, given by way of example in conjunction with the accompanying drawings wherein:

FIG. 1 shows an example of a wireless communication system in accordance with an embodiment;

FIG. 2 shows a functional block diagram of a WTRU and an eNB of FIG. 1;

FIG. 3 is a block diagram of a transmit diversity scheme in accordance with an embodiment;

FIG. 4 shows a S-SCH symbol structure in accordance with the embodiment shown in FIG. 3;

FIG. 5 shows a S-SCH with preceding in accordance with the embodiment shown in FIG. 3;

FIG. 6 shows a S-SCH symbol structure using 2 interleaved sequences in accordance with the embodiment shown in FIG. 4; and

FIG. 7 shows a S-SCH symbol structure using 2 interleaved sequences and PVS in accordance with the embodiment shown in FIG. 5.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

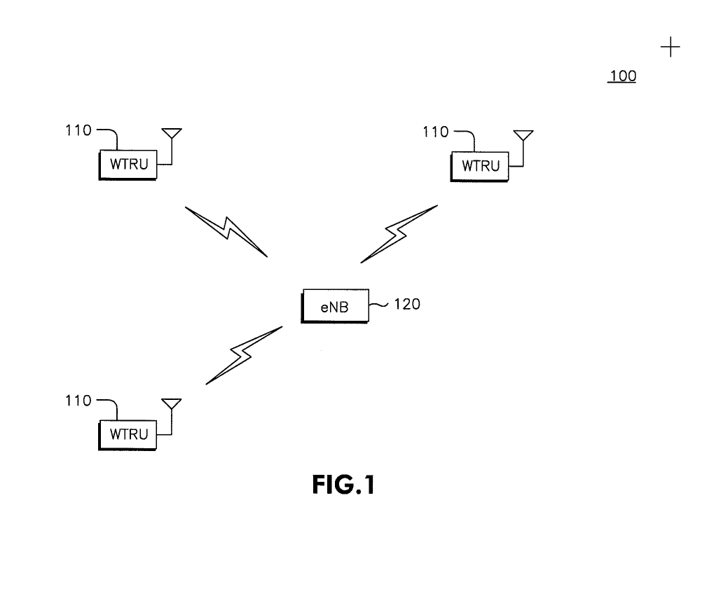

FIG. 1 shows a wireless communication system 100 including a plurality of WTRUs 110 and an e Node-B (eNB) 120. As shown in FIG. 1, the WTRUs 110 are in communication with the eNB 120. Although three WTRUs 110 and one eNB 120 are shown in FIG. 1, it should be noted that any combination of wireless and wired devices may be included in the wireless communication system 100.

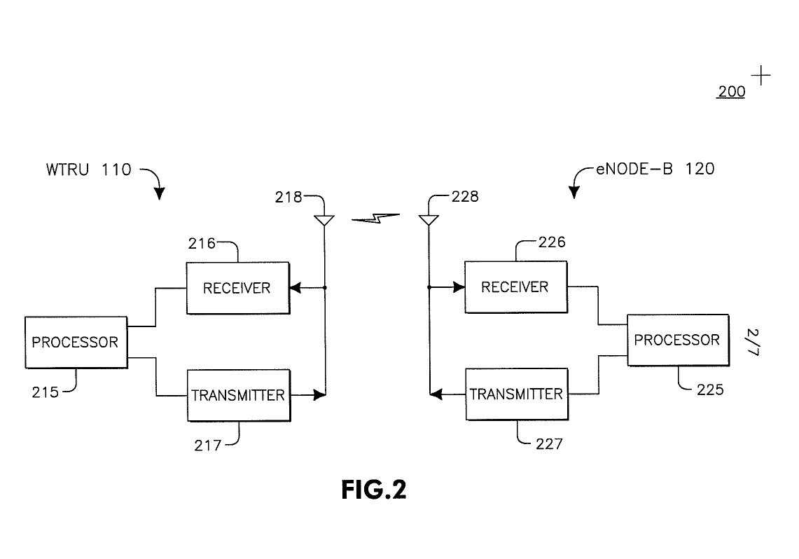

FIG. 2 is a functional block diagram 200 of the WTRU 110 and the eNB 120 of the wireless communication system 100 of FIG. 1. As shown in FIG. 2, the WTRU 110 is in communication with the eNB 120. The WTRU 110 is configured to receive the primary synchronization channel (P-SCH) and secondary synchronization channel (S-SCH) from the eNB 120. Both the eNB and the WTRU are configured to process signals that are modulated and coded.

In addition to the components that may be found in a typical WTRU, the WTRU 110 includes a processor 215, a receiver 216, a transmitter 217, and an antenna 218. The receiver 216 and the transmitter 217 are in communication with the processor 215. The antenna 218 is in communication with both the receiver 216 and the transmitter 217 to facilitate the transmission and reception of wireless data.

In addition to the components that may be found in a typical eNB, the eNB 120 includes a processor 225, a receiver 226, a transmitter 227, and an antenna 228. The receiver 226 and the transmitter 227 are in communication with the processor 225. The antenna 228 is in communication with both the receiver 226 and the transmitter 227 to facilitate the transmission and reception of wireless data.

In one embodiment, a combined FSTD and PVS transmit diversity scheme is used for S-SCH symbol transmission in E-UTRA. This transmit diversity scheme allows S-SCH detection at the WTRU without prior knowledge of the number of transmit antennas of the cell. The number of transmit antennas using the transmit diversity technique is transparent to the WTRU, resulting in simple and efficient detection of the S-SCH. The transmit diversity technique also carries more information about the cell such as, but not limited to, reference signal hopping indicators and a number of transmit antennas for the broadcast channel

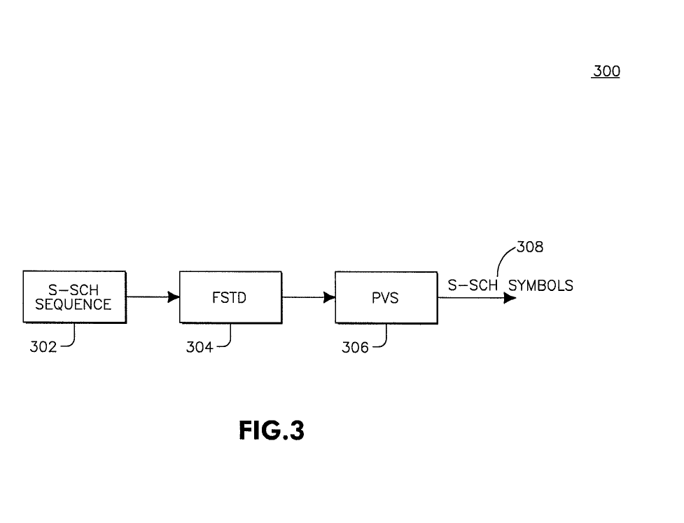

FIG. 3 is a block diagram of an S-SCH transmit diversity scheme 300 in accordance with one embodiment. An S-SCH sequence 302 is input into a FSTD processor 304, as explained herein. The FSTD processor may be includes in processor 225 in the eNB of FIG. 2. The signal is then input into a PVS processor 306, as explained herein. The PVS processor 306 may also be included in processor 225 of the eNB of FIG. 2. The output of the PVS processor 306 are the S-SCH symbols 308 which are then transmitted. The S-SCH symbols 308 may be transmitted by the transmitter 227 as shown in FIG. 2. A robust S-SCH design may provide full transmit diversity gain for S-SCH. A robust S-SCH transmission design may also provide a sufficient number of cell (group) IDs, cell-specific parameters, and other cell related information. The information carried by a plurality of S-SCH symbols may be used to convey the number of cell (group) IDs and cell specific information, such as a reference signal hopping indicator and the number of transmit antennas for the broadcast channel (BCH), for example.

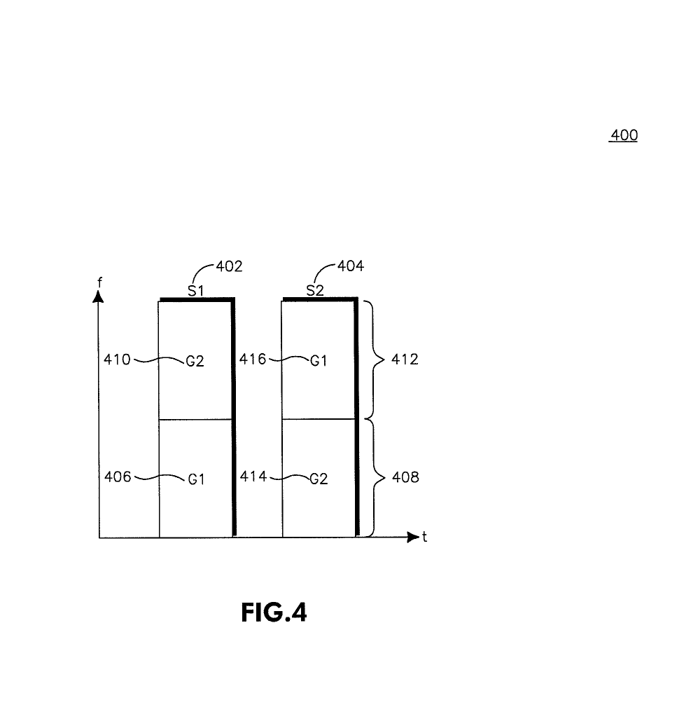

FIG. 4 is a diagram showing an S-SCH symbol structure 400 in accordance with the embodiment shown in FIG. 3. After the S-SCH sequence 302 of FIG. 3, is processed through the FSTD processor 304 of FIG. 3, the result is two separate S-SCH transmission symbols, S1 (402) and S2 (404). S1 (402) is the first S-SCH symbol and has a Constant Amplitude Zero Auto-correlation Code (CAZAC) sequence, shown as G1 (406), transmitted in the lower band 408 of the central bandwidth, and a second CAZAC sequence, shown as G2 (410), transmitted in the upper band 412 of the central bandwidth. The central bandwidth may be, for example, 1.25 MHz or 2.5 Mhz. One skilled in the art may recognize that the methods and apparatus disclosed herein are not frequency specific. The CAZAC sequence may be, for example, a Generalized Chirp-like (GCL) sequence, a Zadoff-Chu sequence, or the like.

The second S-SCH symbol, S2 (404) is a mirror version of the first S-SCH symbol S1 (402). The sequence G2 (414) is transmitted in the lower band 408, and the sequence G1 (416) is transmitted in the upper band 412.

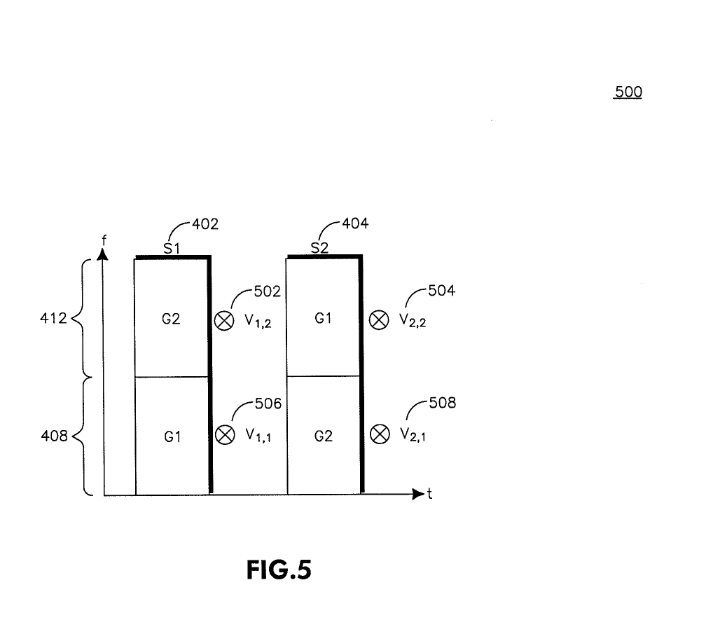

FIG. 5 shows an S-SCH with a precoding matrix 500 in accordance with the embodiment shown in FIG. 3. The precoding matrix is applied to S1 (402) and S2 (404) of FIG. 4. The upper band 412 of S1 (402) is multiplied by V_{1,2} (502) and the upper band 412 of S2 (404) is multiplied by V_{2,2} (504). The lower band 408 of S1 (402) is multiplied by V_{1,1} (506) and the lower band 408 of S2 (404) is multiplied by V_{2,1} (508). V_{1,1}, V_{2,2}, V_{2,1} and V_{2,2} are the elements of a precoding matrix when PVS is used. The precoding matrix V is represented by:

$$V = [ \begin{matrix}{V}_{1 , 1} & {V}_{1 , 2} \\ {V}_{2 , 1} & {V}_{2 , 2}\end{matrix} ] \qquad ( Equation 1 )$$

where Vᵢⱼ is the (1,j)^{th} element of the precoding matrix.

In general, let N_{V} denote the number of different precoding matrices used for S-SCH symbols. For each S-SCH symbol, its equivalent is multiplied by a precoding vector. Consider a precoding matrix:

$$V = [ \begin{matrix}1 & j \\ - j & 1\end{matrix} ] \cdot {e}^{j k θ} , where θ = 0 , \frac{π}{2} , π , \frac{3 π}{2} . \qquad ( Equation 2 )$$

Then, N_{V}=4. Furthermore, the value k can be fixed during one OFDM symbol duration or it can be in a range of 1≦k≦K, where K≦N_{G}, where N_{G} is the sequence length of CAZAC sequence G1 or G2. N_{G}_{₁} and N_{G}_{₂} can be defined as the sequence lengths of G1 (406) and G2 (408), respectively. The maximum number of hypotheses that can be supported is equal to:

N_{G}_{₁}−1×N_{G}_{₂}−1×N_{V}. (Equation 3)

For example, if N_{G}_{₁}=N_{G}_{₂}=31 and N_{V}=4, then the maximum number of hypotheses that can be supported equals 3600 (30×30×4). The pair of S-SCH symbols can be transmitted Q times. For example, if Q=1, the symbols are transmitted every radio frame, where a radio frame is 10 ms in length. The time distance between two S-SCH symbols may be fixed.

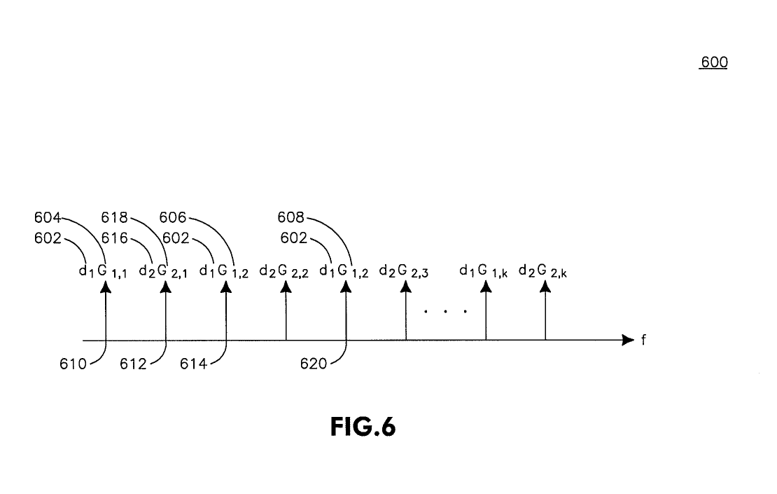

FIG. 6 shows a S-SCH symbol structure using 2 interleaved sequences in accordance with the embodiment shown in FIG. 4. Integer M CAZAC sequences of length K may be mapped to subcarriers in an interleaved pattern to generate one S-SCH symbol. If M equals 2, for example, a first subcarrier 610 carries d1 (602) multiplied by G_{1,1} (604), where d₁ (602) is the first data symbol carried on the S-SCH and G_{1,1} (604) is the first chip/symbol of the first CAZAC sequence with a length K. A third subcarrier 614 carries d1 (602) multiplied by G_{1,2} (606). The fifth subcarrier 620 carries d₁ (602) multiplied by G_{1,3} (608). The second subcarrier 612 carries d₂ (616), which is the second data symbol carried on the S-SCH, multiplied by G_{2,1} (618), which is the first chip/symbol of the second CAZAC sequence with length K. Each CAZAC sequence may carry an information symbol (such as BPSK modulation or QPSK modulation). That is, each information symbol may be spread by a CAZAC sequence of length K. The K spread symbols may be mapped to equal-distant subcarriers in an interleaved pattern. Information symbols may be mapped to non-overlapping subcarriers after spreading.

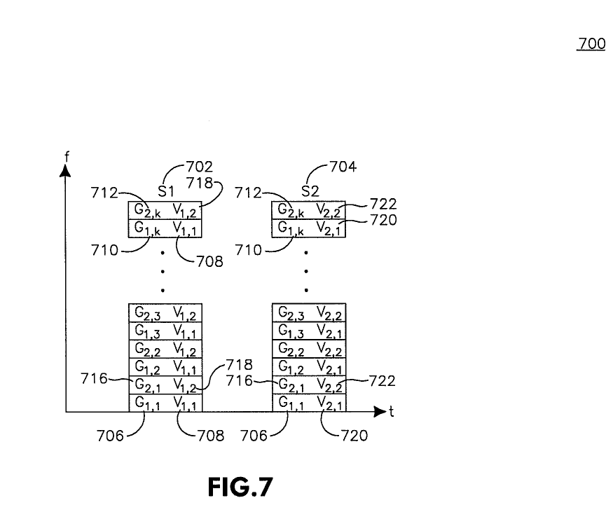

FIG. 7 shows an S-SCH symbol structure using 2 interleaved sequences and PVS 700 in accordance with the embodiment shown in FIG. 5. Let M=2, for example. The two interleaved CAZAC sequences in the first S-SCH symbol S1 (702) are precoded by └V_{1,1}V_{1,2}┘. Similarly, the two interleaved CAZAC sequences in the second S-SCH symbol (704) are precoded by └v_{2,1}v_{2,2}┘. The precoding matrix for the pair of S-SCH symbols is equivalent to

$$[ \begin{matrix}{V}_{1 , 1} & {V}_{1 , 2} \\ {V}_{2 , 1} & {V}_{2 , 2}\end{matrix} ] .$$

Turning to FIG. 7, and by way of example, G_{1,1} (706) is precoded by V_{1,1} (708) in the first S-SCH symbol S1 (702). G_{1,1} (706) is precoded by V_{2,1} (722) in the second S-SCH symbol S2 (704). G_{2,1} (716) is precoded by V_{1,2} (718) in the first S-SCH symbol S1 (702) and G_{2,1} (716) is precoded by V_{2,2} (722) in the second SCH symbol S2 (704). More generally, in the first symbol S1 (702), G_{1,k} (710) is precoded by V_{1,1} (708) and G_{2,K} (712) is precoded by V_{1,2} (718) and in the second SCH symbol S2 (704) G_{1,k} (710) is precoded by V_{2,1} (720) and G_{2,k} is precoded by V_{2,2} (722). The maximum number of hypotheses supported is equal to N_{V}×(K−1)². For example, if K=31 and N_{V}=4, then the maximum number of hypotheses supported equals 3600. A pair of S-SCH symbols may be transmitted Q times every radio frame (10 ms). The time distance between any two S-SCH symbols is fixed.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of providing transmit diversity for a secondary synchronization channel (S-SCH), the method comprising:
generating a S-SCH signal;
performing a frequency switched transmit diversity (FSTD) process on the S-SCH signal to create a first processed signal;
performing a precoding vector switching (PVS) process on the first processed signal to create a processed S-SCH signal; and
transmitting the processed S-SCH signal.

2. The method as in claim 1 further comprising transmitting a cell identifier (ID) and cell specific information in the processed S-SCH signal.

3. The method as in claim 2 wherein the cell specific information comprises reference signal hopping indicators and a number of broadcast channel (BCH) transmit antennas.

4. The method as in claim 1 further comprising processing the S-SCH signal with the FSTD process to obtain:
an orthogonal frequency domain multiplexed (OFDM) symbol with a first orthogonal sequence in a lower bandwidth and a second orthogonal sequence in an upper bandwidth.

5. The method as in claim 1 further comprising processing the S-SCH signal with the FSTD process to obtain:
a first orthogonal frequency domain multiplexed (OFDM) symbol with a first sequence in a lower bandwidth and a second sequence in an upper bandwidth; and
a second OFDM symbol with the first sequence in the upper bandwidth and the second sequence in the lower bandwidth.

6. The method as in claim 5 wherein first and second sequences are a Generalized Chirp-like (GCL) sequence.

7. The method as in claim 5 wherein the first and second sequences are a Zadoff-Chu sequence.

8. The method as in claim 5 further comprising applying a precoding matrix to the first and second symbols.

9. The method as in claim 5 wherein a maximum number of hypotheses is a function of a sequence length of the first sequence, a sequence length of the second sequence and a number of different precoding matrices used for the symbols.

10. A method of providing transmit diversity for a secondary synchronization channel (S-SCH), the method comprising;
generating a S-SCH symbol by multiplying the S-SCH symbol by a spreading sequence; and
mapping the spread S-SCH symbol to non-overlapping subcarriers in an interleaved pattern

11. The method as in claim 10 wherein the subcarriers are equidistant across the bandwidth.

12. The method as in claim 10 further comprising multiplying the mapped S-SCH symbols by a precoding vector.
